(19) United States
(12) Patent Application Publication
(10) Pub. No.: US 2026/0095920 A1
(43) Pub. Date: Apr. 2, 2026

(54) DETECTION PROCESSING METHOD AND APPARATUS, AND TERMINAL

(71) Applicant: VIVO MOBILE COMMUNICATION CO., LTD., Guangdong (CN)

(72) Inventor: Li CHEN, Guangdong (CN)

(73) Assignee: VIVO MOBILE COMMUNICATION CO., LTD., Guangdong (CN)

(21) Appl. No.: 19/403,687

(22) Filed: Nov. 28, 2025

Related U.S. Application Data
(63) Continuation of application No. PCT/CN2024/094827, filed on May 23, 2024.

(30) Foreign Application Priority Data
May 30, 2023 (CN) 202310625877.9

(51) Int. Cl. H04W 72/232; H04W 72/542; H04W 74/0836

(52) U.S. Cl. CPC H04W 72/232; H04W 72/542; H04W 74/0836

(57) ABSTRACT

This application discloses a detection processing method and apparatus, and UE, and belongs to the field of communication technologies. The detection processing method in embodiments of this application includes: detecting, by UE, a downlink channel; and performing, by the UE, a first operation when a first condition is met, where the first operation includes a related operation of a contention resolution failure, and the first condition includes at least one of the following: the downlink channel includes a PDSCH, and the PDSCH does not match a capability of the UE; and the downlink channel includes a PDCCH, and a resource of a PDSCH scheduled by the PDCCH does not match a capability of the UE.

### CROSS-REFERENCE TO RELATED APPLICATIONS

This application is a continuation application of International Application No. PCT/CN2024/094827, filed on May 23, 2024, which claims priority to Chinese Patent Application No. 202310625877.9 filed in China on May 30, 2023, which of both are incorporated herein by reference in its entirety.

### TECHNICAL FIELD

This application pertains to the field of communication technologies, and specifically relates to a detection processing method and apparatus, and user equipment (UE).

### BACKGROUND

In some communication systems, a plurality of UE types are supported, and some UE types may correspond to different capabilities. In this way, during random access, a physical downlink shared channel (PDSCH) scheduled by a network side may not match capabilities of some UEs, and a resource of the PDSCH scheduled by the network side may not match capabilities of some UEs.

### SUMMARY

According to a first aspect, a detection processing method is provided, including:
detecting, by UE, a downlink channel; and
performing, by the UE, a first operation when a first condition is met, where the first operation includes a related operation of a contention resolution failure; where
the first condition includes at least one of the following:
the downlink channel includes a physical downlink shared channel (PDSCH), and the PDSCH does not match a capability of the UE;
the downlink channel includes a physical downlink shared channel (PDSCH), and a resource of the PDSCH exceeds a first preset threshold;
the downlink channel includes a physical downlink control channel (PDCCH), and a resource of a PDSCH scheduled by the PDCCH does not match a capability of the UE;
the downlink channel includes a PDCCH, and a resource of a PDSCH scheduled by the PDCCH exceeds a first preset threshold;
the downlink channel includes a PDCCH, and the PDCCH does not match a capability of the UE;
the downlink channel includes a PDCCH, and a resource scheduled by the PDCCH exceeds a second preset threshold;
the downlink channel includes a PDSCH, and the PDSCH fails to be demodulated; and
the downlink channel includes a PDCCH, and a PDSCH scheduled by the PDCCH fails to be demodulated.

According to a second aspect, a detection processing apparatus is provided, including:
a detection module, configured to detect a downlink channel; and
a first execution module, configured to perform a first operation when a first condition is met, where the first operation includes a related operation of a contention resolution failure; where
the first condition includes at least one of the following:
the downlink channel includes a physical downlink shared channel (PDSCH), and the PDSCH does not match a capability of the UE;
the downlink channel includes a physical downlink shared channel (PDSCH), and a resource of the PDSCH exceeds a first preset threshold;
the downlink channel includes a physical downlink control channel (PDCCH), and a resource of a PDSCH scheduled by the PDCCH does not match a capability of the UE;
the downlink channel includes a PDCCH, and a resource of a PDSCH scheduled by the PDCCH exceeds a first preset threshold;
the downlink channel includes a PDCCH, and the PDCCH does not match a capability of the UE;
the downlink channel includes a PDCCH, and a resource scheduled by the PDCCH exceeds a second preset threshold;
the downlink channel includes a PDSCH, and the PDSCH fails to be demodulated; and
the downlink channel includes a PDCCH, and a PDSCH scheduled by the PDCCH fails to be demodulated.

According to a third aspect, UE is provided. The UE includes a processor and a memory, the memory stores a program or instructions capable of being run on the processor, and when the program or the instructions are executed by the processor, the steps of the detection processing method according to the embodiments of this application are implemented.

According to a fourth aspect, UE is provided, including a processor and a communication interface. The communication interface is configured to detect a downlink channel. The processor is configured to perform a first operation when a first condition is met, where the first operation includes a related operation of a contention resolution failure, and the first condition includes at least one of the following: the downlink channel includes a physical downlink shared channel (PDSCH), and the PDSCH does not match a capability of the UE; the downlink channel includes a physical downlink shared channel (PDSCH), and a resource of the PDSCH exceeds a first preset threshold; the downlink channel includes a physical downlink control channel (PDCCH), and a resource of a PDSCH scheduled by the PDCCH does not match a capability of the UE; the downlink channel includes a PDCCH, and a resource of a PDSCH scheduled by the PDCCH exceeds a first preset threshold; the downlink channel includes a PDCCH, and the PDCCH does not match a capability of the UE; the downlink channel includes a PDCCH, and a resource scheduled by the PDCCH exceeds a second preset threshold; the downlink channel includes a PDSCH, and the PDSCH fails to be demodulated; and the downlink channel includes a PDCCH, and a PDSCH scheduled by the PDCCH fails to be demodulated.

According to a fifth aspect, a readable storage medium is provided. The readable storage medium stores a program or instructions, and when the program or the instructions are executed by a processor, the steps of the detection processing method according to the embodiments of this application are implemented.

According to a sixth aspect, a chip is provided. The chip includes a processor and a communication interface, the communication interface is coupled to the processor, and the processor is configured to run a program or instructions to implement the detection processing method according to the embodiments of this application.

According to a seventh aspect, a computer program/program product is provided. The computer program/program product is stored in a storage medium, and the computer program/program product is executed by at least one processor to implement the steps of the detection processing method according to the embodiments of this application.

### BRIEF DESCRIPTION OF DRAWINGS

FIG. 1 is a block diagram of a wireless communication system to which embodiments of this application are applicable;

FIG. 2 is a schematic diagram of random access according to an embodiment of this application;

FIG. 3 is a schematic diagram of random access according to an embodiment of this application;

FIG. 4 is a flowchart of a detection processing method according to an embodiment of this application;

FIG. 5 is a structural diagram of a detection processing apparatus according to an embodiment of this application;

FIG. 6 is a structural diagram of a communication device according to an embodiment of this application; and

FIG. 7 is a structural diagram of UE according to an embodiment of this application.

### DESCRIPTION OF EMBODIMENTS

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

Terms such as “first” and “second” in this application are used to distinguish between similar objects, and are not used to describe a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and a quantity of objects is not limited. For example, there may be one or more first objects. In addition, “or” in this application represents at least one of connected objects. For example, “A or B” covers three solutions, that is, solution 1: including A and not including B; solution 2: including B and not including A; and solution 3: including A and B. The character “/” generally indicates an “or” relationship between associated objects.

The term “indication” in this application may be either a direct indication (or an explicit indication) or an indirect indication (or an implicit indication). A direct indication may be understood as: A transmitter explicitly notifies, in a transmitted indication, a receiver of content such as specific information, an operation that needs to be performed, or a request content. An indirect indication may be understood as: A receiver determines corresponding information based on an indication sent by a transmitter, or performs determining and determines, based on a determining result, an operation that needs to be performed, a request result, or the like.

As described above, in some communication systems, a plurality of UE types are supported, and some UE types may correspond to different capabilities. In this way, during random access, a physical downlink shared channel (physical downlink shared channel, PDSCH) scheduled by a network side may not match capabilities of some UEs, and a resource of the PDSCH scheduled by the network side may not match capabilities of some UEs. In some related technologies, for these cases that do not match a capability of UE, a processing behavior of the UE is not clear. That is, for these cases that do not match the capability of the UE, the UE cannot perform communication processing, which results in relatively poor communication performance of the UE.

Embodiments of this application provide a detection processing method and apparatus, and UE, which can resolve a problem of relatively poor communication performance of UE.

In the embodiments of this application, UE detects a downlink channel, and the UE performs a first operation when the foregoing first condition is met, where the first operation includes a related operation of a contention resolution failure. In this way, the related operation of the contention resolution failure is performed when the first condition is met, thereby improving communication performance of the UE.

It should be noted that technologies described in the embodiments of this application are not limited to a Long Term Evolution (LTE)/LTE-Advanced (LTE-A) system, and may further be applied to other wireless communication systems such as Code Division Multiple Access (CDMA), Time Division Multiple Access (TDMA), Frequency Division Multiple Access (FDMA), Orthogonal Frequency Division Multiple Access (OFDMA), single-carrier frequency division multiple access (SC-FDMA), or other systems. The terms “system” and “network” in the embodiments of this application may be used interchangeably. The technologies described can be applied to both the systems and the radio technologies mentioned above as well as to other systems and radio technologies. A new radio (NR) system is described in the following description for illustrative purposes, and NR terms are used in most of the following description, although these technologies can also be applied to communication systems other than the NR system application, such as the 6^{th} generation (6G) communication system.

FIG. 1 is a block diagram of a wireless communication system to which the embodiments of this application may be applied. The wireless communication system includes UE 11 and a network side device 12. The UE 11 may be UE side device such as a mobile phone, a tablet personal computer, a laptop computer, a notebook computer, a personal digital assistant (PDA), a palmtop computer, a netbook, an ultra-mobile personal computer (UMPC), a mobile Internet device (MID), an augmented reality (AR) device, a virtual reality (VR) device, a robot, a wearable device, a flight vehicle, vehicle user equipment (VUE), ship-borne equipment, pedestrian user equipment (PUE), a smart home device (a home device with a wireless communication function, such as a refrigerator, a television, a washing machine, or furniture), a game console, a personal computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet bracelet, a smart anklet chain, or the like), a smart wrist strap, a smart dress, and the like. The vehicle user equipment may also be referred to as a vehicle-mounted UE, a vehicle-mounted controller, a vehicle-mounted module, a vehicle-mounted component, a vehicle-mounted chip, a vehicle-mounted unit, or the like. It should be noted that a specific type of the UE 11 is not limited in the embodiments of this application. The network side device 12 may include an access network device or a core network device. The access network device may also be referred to as a radio access network (RAN) device, a radio access network function, or a radio access network unit. The access network device may include a base station, a wireless local area network (WLAN) access point (AP), a wireless fidelity (WiFi) node, and the like. The base station may be referred to as a NodeB (NB), an evolved NodeB (eNB), a next-generation node B (gNB), a new radio NodeB (NR Node B), an access point, a relay base station (RBS), a serving base station (SBS), a base transceiver station (BTS), a radio base station, a radio transceiver, a basic service set (BSS), an extended service set (ESS), a home NodeB (HNB), a home evolved NodeB, a transmission reception point (TRP), or another suitable term in the field, provided that a same technical effect is achieved, and the base station is not limited to a specific technical vocabulary. It should be noted that only a base station in an NR system is used as an example in this embodiment of this application for description, and a specific type of the base station is not limited.

The core network device may include but is not limited to at least one of the following: a core network node, a core network function, a mobility management entity (MME), an access and mobility management function (AMF), a session management function (SMF), a user plane function (UPF), a policy control function (PCF), a policy and charging rules function (PCRF) unit, an edge application service discovery function (EASDF), unified data management (UDM), unified data repository (UDR), a home subscriber server (HSS), centralized network configuration (CNC), a network repository function (NRF), a network exposure function (NEF), a local NEF (L-NEF), a binding support function (BSF), an application function (AF), and the like. It should be noted that, in the embodiments of this application, only a core network device in an NR system is used as an example for description, and a specific type of the core network device is not limited.

In some embodiments, in a four-step contention random access channel (RACH) process, after a message 1 (Msg1) and a message 2 (Msg2) are passed, a plurality of UEs may use a same physical random access channel (PRACH) preamble on a same random access occasion (RACH occasion) to send the Msg 1, that is, use a same PRACH preamble on a same time-frequency resource to send the Msg1. In this way, a temporary cell radio network temporary identifier (T-C-RNTI) in the Msg2 may be used by a plurality of UEs. In this way, contention resolution may be performed by using a message 3 (Msg3)/a message 4 (Msg4), and a definite cell radio network temporary identifier (C-RNTI) is determined for the UE, so as to avoid a conflict.

In some embodiments, in a contention resolution mechanism, resolution is performed based on whether the UE already has a C-RNTI, which may be specifically as follows:

If the UE already has a C-RNTI, for example, a RACH triggered by a physical downlink control channel (PDCCH) order during beam failure recovery, or a RACH triggered by a medium access control (MAC)/radio resource control (RRC) layer, and PDCCH transmission is scrambled by using the C-RNTI and includes a newly transmitted uplink grant (UL grant), the UE sends a C-RNTI MAC CE on the Msg3. Then, the PDCCH may be successfully demodulated by using the C-RNTI. Therefore, it is considered that random access succeeds. Because the C-RNTI is UE specific, other UEs do not know this C-RNTI and cannot demodulate the PDCCH.

If the UE has no C-RNTI, the UE sends a common control channel (CCCH) service data unit (SDU), such as an RRC setup request, on the Msg3. These CCCH SDUs include an identity of contention resolution, and then the UE successfully demodulates a PDCCH of the Msg4 by using the T-C-RNTI.

If a media access control control element (MAC CE) of a contention resolution identify in the Msg4 can be successfully demodulated at the same time, and an identity in the MAC CE is consistent with that sent by the UE in the Msg3, the UE considers that a RACH process succeeds, and officially converts the T-C-RNTI into a C-RNTI.

Otherwise, the UE discards the T-C-RNTI, considers that contention resolution fails, and discards a demodulated MAC protocol data unit (PDU).

In some implementations, a contention-based random access process and a non-contention-based random access process are included.

In a contention-based four-step random access process (or referred to as 4-step RACH for short), the UE first sends a Msg1 including a preamble to a network; after detecting the preamble, the network sends a Msg2/random access response (RAR) message including a number of the preamble detected by the network and an uplink radio resource allocated to the UE to send a Msg3; after receiving the Msg2, the UE acknowledges that at least one of numbers of preambles carried in the Msg2 is consistent with the number of the preamble sent by the UE, and sends, based on a resource indicated by the RAR, a Msg3 including contention resolution information; after receiving the Msg3, the network sends a Msg4 including the contention resolution information; and after receiving the Msg4, the UE acknowledges that the resolution information is consistent with that sent by the UE in the Msg3. In this case, 4-step random access is completed.

The network includes uplink grant (UL grant) information in the RAR to indicate Msg3 physical uplink shared channel (PUSCH) scheduling information, and includes information such as a RACH preamble identifier (RAPID), a T-C-RNTI, and a timing advance (TA). If the network fails to receive the Msg3 PUSCH, retransmission of the Msg3 PUSCH may be scheduled in a PDCCH scrambled by the T-C-RNTI.

For the contention-based random access process, different UEs randomly select preambles for transmission. In this way, different UEs may select a same preamble on a same time-frequency radio (RO) resource for sending. This case may be understood as a preamble conflict of the UE. In this case, different UEs receive a same RAR, and in this case, different UEs transmit a MSG3 PUSCH based on scheduling information in the RAR UL grant. Because a related technology does not support repeated transmission of the MSG3 PUSCH, the network can demodulate, on one MSG3 PUSCH scheduling resource, a PUSCH (including contention resolution information) sent by only one UE. Therefore, the network includes, in the MSG4, the contention resolution information received in the MSG3. If the contention resolution information in the MSG4 received by the UE matches the contention resolution information sent by the UE in the MSG3 PUSCH, the UE considers that contention resolution succeeds. If the contention resolution information in the MSG4 received by the UE does not match the contention resolution information sent by the UE in the MSG3 PUSCH, it is considered that contention resolution fails.

In some implementations, if contention resolution fails, the UE re-selects a RACH sending resource, sends a physical random access channel (PRACH), and performs a next random access attempt.

In some implementations, a two-step random access process (or referred to as 2-step RACH for short) is supported. The first step is that UE sends a message A (MsgA) to a network side. After receiving the MsgA, a network side sends a message B (MsgB) message to the UE. If the UE does not receive the MsgB within a specific period of time, the UE adds up a counter for counting a quantity of times of sending the MsgA and resends the MsgA. If the counter for counting the quantity of times of sending the MsgA reaches a specific threshold, the UE may switch from the 2-step random access process to the 4-step random access process. The MsgA includes a MsgA preamble part and a MsgA PUSCH part. The preamble part is sent on a random access occasion (RACH Occasion, RO) used for 2-step RACH, and the PUSCH part is sent on a MsgA PUSCH resource associated with sending of the MsgA preamble and the RO. The MsgA PUSCH resource is a group of PUSCH resources configured relative to each PRACH slot, and includes a time-frequency resource and a DMRS resource.

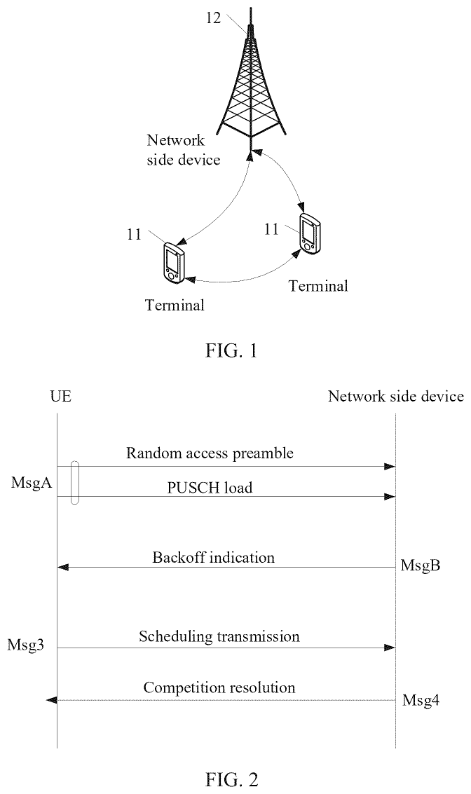

In some implementations, a main process of 2-step RA may be shown in FIG. 2, as follows:

UE sends a MsgA (MsgA PRACH+MsgA PUSCH) to a network side.

After receiving the MsgA, the network sends a MsgB to the UE.

If the MsgB received by the UE includes a fallback RAR (FallbackRAR) that matches a sent MsgA PRACH, the UE extracts data from a MsgA buffer and stores the data in a Msg3 buffer. Then, the UE sends the Msg3 to the network side, and then performs contention resolution.

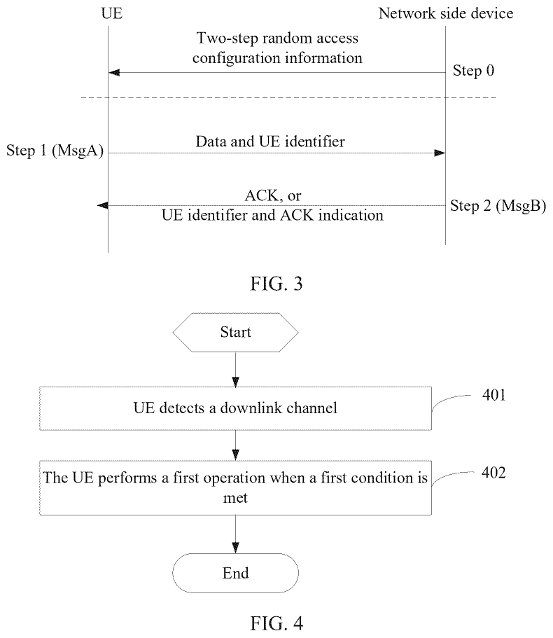

In some implementations, a main process of 2-step RA may be shown in FIG. 3, as follows:

Step 0: A network side configures configuration information of two-step random access for UE, for example, including transmission resource information corresponding to a MsgA and a MsgB.

Step 1: The UE triggers a 2-step RACH process, and sends request information (MsgA) to the network side, for example, sends the request information by using a PUSCH. In addition, the UE may also send PRACH information to the network side.

Step 2: After sending the MsgA, the UE monitors receiving of the MsgB in a period of time (that is, a RAR window). If the UE fails to receive the MsgB, the UE resends the MsgA.

For UE in a connected state, when the 2-step RACH is triggered due to arrival of uplink data and uplink out-of-synchronization, after the network side successfully receives the MsgA, the network side sends the MsgB. For sending of the MsgB, the network side schedules sending of one PDSCH by using a C-RNTI PDCCH, and the PDSCH includes a media access control control element (MAC CE) of an absolute uplink timing of the UE for uplink synchronization of the UE.

With reference to the accompanying drawings, a detection processing method and apparatus, and UE in the embodiments of this application are described in detail below by using specific embodiments and application scenarios thereof.

Referring to FIG. 4, FIG. 4 is a flowchart of a detection processing method according to an embodiment of this application. As shown in FIG. 4, the method includes the following steps:

Step 401: UE detects a downlink channel.

The foregoing detection of the downlink channel may be: detecting, by the UE, a PDCCH and/or a PDSCH.

In this embodiment of this application, the PDCCH or the PDSCH may be a PDCCH or a PDSCH in a random access process. For example, the PDCCH may be a PDCCH corresponding to a Msg4 in a four-step random access process, and the PDCCH includes downlink control information (DCI).

The PDSCH may include at least one of the following:
a message 4 in four-step random access, for example, a corresponding MAC PDU; and
a message B (MsgB) in two-step random access.

In some implementations, the PDSCH is scheduled by using the PDCCH.

Step 202: The UE performs a first operation when a first condition is met, where the first operation includes a related operation of a contention resolution failure.

The first condition includes at least one of the following:
the downlink channel includes a PDSCH, and the PDSCH does not match a capability of the UE;
the downlink channel includes a PDSCH, and a resource of the PDSCH exceeds a first preset threshold;
the downlink channel includes a PDCCH, and a resource of a PDSCH scheduled by the PDCCH does not match a capability of the UE;
the downlink channel includes a PDCCH, and a resource of a PDSCH scheduled by the PDCCH exceeds a first preset threshold;
the downlink channel includes a PDCCH, and the PDCCH does not match a capability of the UE;
the downlink channel includes a PDCCH, and a resource scheduled by the PDCCH exceeds a second preset threshold;
the downlink channel includes a PDSCH, and the PDSCH fails to be demodulated; and
the downlink channel includes a PDCCH, and a PDSCH scheduled by the PDCCH fails to be demodulated.

The foregoing first condition may be specified in a protocol or configured by a network side.

In some implementations, the capability of the UE may include at least one of the following:
radio frequency (RF) bandwidth, baseband (BB) bandwidth, operating bandwidth, a quantity of antennas, a codeword, and a time domain processing interval.

In some implementations, the radio frequency bandwidth may be radio frequency bandwidth of the UE or radio frequency bandwidth supported by the UE, the baseband bandwidth may be baseband bandwidth of the UE or baseband bandwidth supported by the UE, the operating bandwidth may be operating bandwidth of the UE or operating bandwidth supported by the UE, the quantity of antennas may be a quantity of antennas supported by the UE or a quantity of antennas supported by the UE, the codeword may be a codeword of the UE or a codeword supported by the UE, and the time domain processing interval may be a time domain processing interval of the UE or a time domain processing interval supported by the UE.

In some implementations, the capability of the UE may include at least one of the following:

RF bandwidth supported by the UE, baseband bandwidth supported by the UE, operating bandwidth supported by the UE, a quantity of antennas supported by the UE, a codeword supported by the UE, and a time domain processing interval supported by the UE.

That the PDSCH does not match the capability of the UE may be understood as that the UE is unable to or cannot demodulate the PDSCH, or the UE is unable to or cannot process the PDSCH, or a resource of the PDSCH exceeds the capability of the UE.

That the resource of the PDSCH exceeds the first preset threshold may be that a resource size or resource bandwidth of the PDSCH exceeds the first preset threshold. In some implementations, a resource may also be referred to as bandwidth, and that the resource of the PDSCH exceeds the first preset threshold may also be referred to as that bandwidth of the PDSCH exceeds the first preset threshold.

The resource of the PDSCH may be a resource allocated to the PDSCH, for example, a resource allocated by a PDCCH to the PDSCH, or a resource of a PDSCH scheduled by a PDCCH. The resource is learned by a PDCCH that schedules the PDSCH.

That the resource of the PDSCH scheduled by the PDCCH does not match the capability of the UE may be that a resource size or bandwidth of the PDSCH scheduled by the PDCCH exceeds the capability of the UE.

That the resource of the PDSCH scheduled by the PDCCH exceeds the first preset threshold may be that a resource size or bandwidth of the PDSCH scheduled by the PDCCH exceeds the first preset threshold.

That the PDCCH does not match the capability of the UE may be understood as that the UE is unable to or cannot demodulate the PDCCH, or the UE is unable to or cannot process the PDCCH.

That the resource scheduled by the PDCCH exceeds the second preset threshold may be that a resource of a PDSCH scheduled by the PDCCH exceeds the second preset threshold. In addition, the second preset threshold may be the same as or different from the first preset threshold.

Failing to demodulate the PDSCH may be: the UE is unable to demodulate the PDSCH, or the UE cannot demodulate the PDSCH.

Failing to demodulate the PDSCH scheduled by the PDCCH may be: the UE is unable to demodulate the PDSCH scheduled by the PDCCH, or the UE cannot demodulate the PDSCH scheduled by the PDCCH.

The related operation of the contention resolution failure may be an operation used to explicitly indicate the contention resolution failure, or an operation that implicitly indicates the contention resolution failure, or determining the contention resolution failure and a corresponding operation.

In this embodiment of this application, through the foregoing steps, the related operation of the contention resolution failure can be performed when the first condition is met, so that communication performance of the UE can be improved. In addition, by performing the related operation of the contention resolution failure, the UE may be supported to perform next random access when the first condition is met In this way, the UE can be prevented from continuing to wait when the first condition is met, thereby improving access performance of the UE.

In an optional implementation, the UE initiates random access after performing the first operation; or the related operation of the contention resolution failure includes: initiating random access. The random access may also be referred to as a random access attempt, such as a RACH attempt. Specifically, random access is initiated based on the related operation of the contention resolution failure. In this way, because it is unnecessary to wait for expiration of a contention resolution timer, the UE can initiate next access in advance, thereby further improving access performance of the UE.

In an optional implementation, a reason why the PDSCH fails to be demodulated or the PDSCH scheduled by the PDCCH fails to be demodulated includes at least one of the following:
the resource of the PDSCH does not match the capability of the UE; and
the resource of the PDSCH exceeds the first preset threshold.

That the resource of the PDSCH does not match the capability of the UE may be that a resource size or bandwidth of the PDSCH exceeds the capability of the UE.

That the resource of the PDSCH exceeds the first preset threshold may be that a resource size or bandwidth of the PDSCH exceeds the first preset threshold.

In this implementation, the first operation can be performed when the PDSCH fails to be demodulated or the PDSCH scheduled by the PDCCH fails to be demodulated because the resource of the PDSCH does not match the capability of the UE or the resource of the PDSCH exceeds the first preset threshold, to improve access performance of the UE.

In an optional implementation, a value of the first preset threshold includes one of the following:
a value agreed upon in a protocol;
a value configured by a network;
a value corresponding to a receiving capability of the UE or a value corresponding to a processing capability of the UE; and
a value corresponding to receiving capabilities of some UEs of UE type to which the UE belongs, or a value corresponding to processing capabilities of some UEs of UE type to which the UE belongs.

In this implementation, the value of the first preset threshold may be agreed upon in a protocol or configured by a network side, or the value of the first preset threshold corresponds to the capability of the UE. For example, the value of the first preset threshold is a threshold of the capability of the UE, such as a bandwidth threshold. For example, for UE with peak data rate reduction (PR) 1+BB bandwidth reduction, a BB capability of the UE is 5 MHz, and the threshold herein is limited by a BB bandwidth capability of the UE, that is, 5 MHz.

Similarly, a value of the second preset threshold includes one of the following:
a value agreed upon in a protocol;
a value configured by a network;
a value corresponding to a receiving capability of the UE or a value corresponding to a processing capability of the UE; and
a value corresponding to receiving capabilities of some UEs of UE type to which the UE belongs, or a value corresponding to processing capabilities of some UEs of UE type to which the UE belongs.

In an optional implementation, that the UE performs a first operation when a first condition is met includes:

a physical (PHY) layer of the UE sends first indication information to an upper layer of the UE when the physical layer meets the first condition; and
the upper layer of the UE performs the first operation when receiving the first indication information.

The upper layer may be a MAC layer, a radio link control (RLC) layer, a packet data convergence protocol (PDCP) layer, a service data adaptation protocol (SDAP) layer, or a radio resource control (RRC) layer.

In this implementation, the physical layer may trigger, by using the foregoing indication information, the upper layer to perform the first operation, so as to implement cross-layer indication, and the UE can be prevented from continuing to wait on the upper layer, thereby improving access performance of the UE.

It should be noted that, in some implementations, the foregoing operations may not be limited to being performed by the physical layer and the upper layer in this embodiment of this application. For example, in some implementations, determining of the first condition may also be performed by the upper layer, which is not limited thereto.

Optionally, the first indication information is used to indicate any one of the following:
being unable to demodulate the PDSCH;
the PDSCH does not belong to the UE;
the PDSCH does not match the capability of the UE;
the resource of the PDSCH exceeds the first preset threshold;
the resource of the PDSCH scheduled by the PDCCH does not match the capability of the UE;
the resource of the PDSCH scheduled by the PDCCH exceeds the first preset threshold;
the PDCCH does not match the capability of the UE;
the resource scheduled by the PDCCH exceeds the second preset threshold;
the UE fails to demodulate the PDSCH;
the UE fails to demodulate the PDSCH scheduled by the PDCCH; and
the first condition is met.

Being unable to demodulate the PDSCH may be understood as that the UE cannot demodulate the PDSCH.

That the PDSCH does not belong to the UE may be understood as that the PDSCH belongs to another UE.

In this implementation, the physical layer may indicate at least one of the foregoing to the upper layer, so that the upper layer performs the first operation, to improve access performance of the UE.

Optionally, that the PDSCH does not match the capability of the UE includes:
the UE detects a PDCCH scrambled by a radio network temporary identifier (RNTI) of the UE, but the PDSCH scheduled by the PDCCH does not match the capability of the UE;
or
that the resource of the PDSCH scheduled by the PDCCH does not match the capability of the UE includes:
the UE detects a PDCCH scrambled by an RNTI of the UE, but the resource of the PDSCH scheduled by the PDCCH does not match the capability of the UE;
or
that the resource of the PDSCH scheduled by the PDCCH exceeds the first preset threshold includes:
the UE detects a PDCCH scrambled by an RNTI of the UE, but the resource of the PDSCH scheduled by the PDCCH exceeds the first preset threshold;
or
that the PDCCH does not match the capability of the UE includes:
the UE detects a PDCCH scrambled by an RNTI of the UE, but the PDCCH does not match the capability of the UE;
or
that the resource scheduled by the PDCCH exceeds the second preset threshold includes:
the UE detects a PDCCH scrambled by an RNTI of the UE, but the resource scheduled by the PDCCH exceeds the second preset threshold;
or
that the PDSCH fails to be demodulated includes:
the UE detects a PDCCH scrambled by an RNTI of the UE, but fails to demodulate the PDSCH;
or
that the PDSCH scheduled by the PDCCH fails to be demodulated includes:
the UE detects a PDCCH scrambled by an RNTI of the UE, but fails to demodulate the PDSCH scheduled by the PDCCH; where
the RNTI includes:
a T-C-RNTI, or a message B-RNTI (MsgB-RNTI).

The T-C-RNTI is a T-C-RNTI in a four-step random access process, and the MsgB-RNTI is a MsgB-RNTI in a two-step random access process.

In this implementation, when the UE detects the PDCCH scrambled by the RNTI of the UE, the first operation may be performed if the first condition is met, to improve access performance of the UE.

For example, the UE can demodulate a PDCCH, but is unable to demodulate a PDSCH that is scheduled by the PDCCH and that is greater than 5 MHz, thereby performing the first operation.

In an optional implementation, the resource includes at least one of the following:
bandwidth, a frequency domain resource, a time domain resource, a space domain resource, and a code domain resource.

The bandwidth is bandwidth of the PDSCH scheduled by the PDCCH.

The frequency domain resource, the time domain resource, the space domain resource, and the code domain resource are a frequency domain resource, a time domain resource, a space domain resource, and a code domain resource of the PDSCH scheduled by the PDCCH.

The time domain resource may be a listening moment or a listening time period, the frequency domain resource may be a frequency or bandwidth, the space domain resource may be a quantity or an angle of listening antennas, and the code domain resource may be a listening codeword.

During determining of the first condition, capabilities of the UE respectively corresponding to the time domain resource, the frequency domain resource, the space domain resource, and the code domain resource are also capabilities in time domain, frequency domain, code domain, and space domain.

In this implementation, the first operation may be performed when bandwidth, a frequency domain resource, a time domain resource, a space domain resource, or a code domain resource of the PDSCH does not match the capability corresponding to the UE, to improve access performance of the UE.

In an optional implementation, that the PDSCH does not match the capability of the UE includes at least one of the following:
bandwidth of the PDSCH does not match the capability of the UE; and
a resource of the PDSCH does not match the capability of the UE.

That the bandwidth of the PDSCH does not match the capability of the UE may also be referred to as that bandwidth of the PDSCH scheduled by the PDCCH does not match the capability of the UE. That the resource of the PDSCH does not match the capability of the UE may also be referred to as that a resource of the PDSCH scheduled by the PDCCH does not match the capability of the UE.

The bandwidth or the resource of the PDSCH may be bandwidth or a resource of a PDSCH indicated by scheduling information of the PDCCH, that is, bandwidth or a resource of the PDSCH is determined based on the scheduling information of the PDCCH.

That the bandwidth of the PDSCH does not match the capability of the UE may be that bandwidth of the PDSCH exceeds the radio frequency bandwidth of the UE, the baseband bandwidth supported by the UE, or the operating bandwidth supported by the UE, or the UE is unable to or cannot process the PDSCH with the bandwidth.

That the resource of the PDSCH does not match the capability of the UE may be that a resource size or bandwidth of the PDSCH exceeds the capability of the UE, or the UE is unable to or cannot process the PDSCH with the resource.

In this implementation, the first operation is performed when the bandwidth of the PDSCH does not match the capability of the UE or the resource of the PDSCH does not match the capability of the UE, to improve access performance of the UE.

In an optional implementation, the capability of the UE includes at least one of the following:
the receiving capability of the UE;
the processing capability of the UE;
the receiving capabilities of some UEs of the UE type to which the UE belongs; and
the processing capabilities of some UEs of the UE type to which the UE belongs.

The receiving capabilities of some UEs of the UE type to which the UE belongs may be: The UE type to which the UE belongs includes UEs of a plurality of different capabilities, and the capability of the UE is receiving capabilities of some UEs. For example, the UE type includes UEs of a plurality of different capabilities. For example, there may be two implementations for UE type of an enhanced reduced capability UE (eRedCap UE): One is 20 MHz+PR1, and the other is bandwidth (BW) 3/PR3+PR1. Both implementations can reach approximately 10 Mbps required by the eRedCap UE. In this way, if the resource of the PDSCH is greater than 5 MHz, a receiving or processing capability corresponding to UE in the implementation BW3/PR3+PR1 is exceeded, but a receiving or processing capability corresponding to UE in the implementation 20 MHz+PR1 is not exceeded.

The receiving capability of the UE or the processing capability of the UE may include at least one of the following:
radio frequency bandwidth, baseband bandwidth, operating bandwidth, a quantity of antennas, a codeword, and a time domain processing interval.

The receiving capabilities of some UEs or the processing capabilities of some UEs may include at least one of the following:
radio frequency bandwidth of some UEs, baseband bandwidth of some UEs, operating bandwidth of some UEs, quantities of antennas of some UEs, codewords of some UEs, and time domain processing intervals of some UEs.

In this implementation, the first operation may be flexibly triggered based on at least one of the foregoing capabilities, to meet requirements of different services or scenarios of the UE, so as to improve compatibility of the UE.

In an optional implementation, the related operation of the contention resolution failure includes at least one of the following:
determining the contention resolution failure, discarding a T-C-RNTI, stopping a contention resolution timer, discarding an undemodulated PDSCH, and instructing the physical layer to retransmit a random access preamble.

It should be noted that this implementation may be applied to both four-step random access and two-step random access.

The determining the contention resolution failure may be understood as follows: considering that contention resolution fails when the first condition is met, so that it is unnecessary to wait for expiration of the contention resolution timer, and therefore, next random access can be initiated in advance, thereby improving access performance of the UE.

The discarding the T-C-RNTI may be: discarding a T-C-RNTI delivered by the network side, for example, discarding a T-C-RNTI in a Msg2 in a random access process. In this way, the T-C-RNTI is discarded when the first condition is met, and the T-C-RNTI is discarded without a need to wait for expiration of the contention resolution timer. In this way, the UE cannot perform contention resolution based on the T-C-RNTI when the first condition is met, that is, the UE acknowledges the contention resolution failure in advance, and once the UE acknowledges the contention resolution failure, the UE can initiate next random access, that is, the UE initiates next random access in advance, thereby improving access performance of the UE.

The stopping the contention resolution timer may be: disabling the contention resolution timer, that is, stopping the contention resolution timer by disabling the contention resolution timer, so that next random access can be initiated in advance without a need to continue to wait for expiration of the contention resolution timer, thereby improving access performance of the UE.

The discarding the undemodulated PDSCH may be: discarding a detected PDSCH, and once the PDSCH is discarded, contention resolution naturally cannot be performed. In this way, next random access can be initiated in advance without a need to wait for expiration of the contention resolution timer, thereby improving access performance of the UE.

In some implementations, a scheduling configuration of the PDSCH scheduled by the PDCCH may be discarded, and once the scheduling configuration of the PDSCH is discarded, contention resolution naturally cannot be performed. In this way, next random access can be initiated in advance without a need to wait for expiration of the contention resolution timer, thereby improving access performance of the UE.

The instructing the physical layer to retransmit the random access preamble may be: instructing the physical layer to initiate next random access, to initiate next random access in advance, thereby improving access performance of the UE.

In an optional implementation,
when the PDSCH includes a message B in two-step random access, the related operation of the contention resolution failure includes at least one of the following:
determining that a random access response (RAR) fails to be received;
stopping a timing corresponding to a message B response window (MsgB response window);
discarding the undemodulated PDSCH;
instructing the physical layer to retransmit the random access preamble; and
determining that random access fails.

In this implementation, it may be determined, when the first condition is met, that RAR fails to be received. In this way, next random access can be initiated in advance, thereby improving access performance of the UE.

In this implementation, the timing corresponding to the message B response window may be stopped when the first condition is met. In this way, next random access can be initiated in advance, thereby improving access performance of the UE.

In this implementation, the undemodulated PDSCH may be discarded when the first condition is met, to indicate that random access fails. In this way, next random access can be initiated in advance, thereby improving access performance of the UE.

In this implementation, the physical layer may be instructed, when the first condition is met, to retransmit the random access preamble, so that the physical layer retransmits the random access preamble. In this way, next random access can be initiated in advance, thereby improving access performance of the UE.

In this implementation, it may be determined, when the first condition is met, that random access fails. In this way, next random access can be initiated in advance, thereby improving access performance of the UE.

In an optional implementation, when the PDSCH includes a message B in two-step random access, the first condition further includes:
a hybrid automatic repeat request acknowledgement (HARQ-ACK) timing of the PDSCH does not meet a relaxation requirement.

The relaxation requirement is a relaxation requirement, defined in a protocol, for a HARQ-ACK timing.

In this implementation, at least one of the following may be implemented:
performing the first operation when the PDSCH does not match the capability of the UE and a HARQ-ACK timing of the PDSCH does not meet the relaxation requirement;
performing the first operation when the resource of the PDSCH exceeds the first preset threshold and a HARQ-ACK timing of the PDSCH does not meet the relaxation requirement;
performing the first operation when the resource of the PDSCH scheduled by the PDCCH does not match the capability of the UE and a HARQ-ACK timing of the PDSCH does not meet the relaxation requirement;
performing the first operation when the resource of the PDSCH scheduled by the PDCCH exceeds the first preset threshold and a HARQ-ACK timing of the PDSCH does not meet the relaxation requirement;
performing the first operation when the PDCCH does not match the capability of the UE and a HARQ-ACK timing of the PDSCH does not meet the relaxation requirement;
performing the first operation when the resource scheduled by the PDCCH exceeds the second preset threshold and a HARQ-ACK timing of the PDSCH does not meet the relaxation requirement;
performing the first operation when the PDSCH fails to be demodulated and a HARQ-ACK timing of the PDSCH does not meet the relaxation requirement; and
performing the first operation when the PDSCH scheduled by the PDCCH fails to be demodulated and a HARQ-ACK timing of the PDSCH does not meet the relaxation requirement.

In this implementation, in the two-step random access process, the first condition further includes: the HARQ-ACK timing of the PDSCH does not meet the relaxation requirement. In this way, the first operation is performed only when the HARQ-ACK timing of the PDSCH does not meet the relaxation requirement, thereby increasing a random access success rate.

Optionally, when the PDSCH includes a message B in two-step random access, that the PDSCH does not match the capability of the UE includes:
bandwidth of the PDSCH does not match the capability of the UE, and a HARQ-ACK timing of the PDSCH does not meet a relaxation requirement.

In this way, the first operation is performed only when the bandwidth of the PDSCH does not match the capability of the UE and the HARQ-ACK timing of the PDSCH does not meet the relaxation requirement, thereby increasing a random access success rate.

Optionally, when the PDSCH includes a message B in two-step random access, the method further includes:
performing, by the UE, a second operation when a HARQ-ACK timing of the PDSCH meets a relaxation requirement, where the second operation includes at least one of the following:
demodulating the PDSCH; and
transmitting a HARQ of the PDSCH.

In this implementation, the second operation can be performed when the HARQ-ACK timing of the PDSCH meets the relaxation requirement, without considering the capability of the UE. For example, the second operation is also performed when the HARQ-ACK timing of the PDSCH meets the relaxation requirement and at least one of the following is met:
the PDSCH does not match the capability of the UE;
the resource of the PDSCH exceeds the first preset threshold;
the resource of the PDSCH scheduled by the PDCCH does not match the capability of the UE;
the resource of the PDSCH scheduled by the PDCCH exceeds the first preset threshold;
the PDCCH does not match the capability of the UE; and
the resource scheduled by the PDCCH exceeds the second preset threshold.

For example, if the bandwidth of the PDSCH exceeds 5 MHz and the HARQ-ACK timing meets the relaxation requirement, the UE demodulates the PDSCH (that is, a message B) and transmits the HARQ. Otherwise, the first operation is performed.

In this implementation, the second operation is performed when the HARQ-ACK timing of the PDSCH meets the relaxation requirement, so that a random access success rate can be improved.

In an optional implementation, when the first condition is met, and when the UE demodulates the PDCCH, the physical layer of the UE does not send second indication information to the upper layer, where the second indication information is used to indicate that indication information from a PDCCH of a special Cell (Spcell) is received.

In some implementations, the special cell (Spcell) includes a primary cell Pcell or a primary secondary cell PScell.

In this implementation, when the first condition is met and the UE can demodulate the PDCCH, the physical layer of the UE does not report the second indication information to the upper layer, to reduce power consumption of the UE. This is because the upper layer does not need to perform PDCCH-related processing in this case.

In this embodiment of this application, the UE detects the downlink channel, and the UE performs the first operation when the first condition is met, where the first operation includes the related operation of the contention resolution failure. In this way, the related operation of the contention resolution failure is performed when the first condition is met, thereby improving communication performance of the UE.

The method provided in the embodiments of this application is described as examples below by using specific embodiments:

### Embodiment 1

A PHY layer of UE provides an indication (or notification) to an upper layer (Upper layer, that is, a MAC layer) when a first condition is met.

The MAC layer of the UE performs a first operation if the foregoing indication is received from a lower layer (that is, the PHY layer).

The first condition may include at least one of the following:
the UE detects that a PDSCH scheduled by DCI is greater than a preset threshold;
the UE detects that resource allocation scheduled by the DCI is greater than a preset threshold;
the UE detects that a PDSCH scheduled by the DCI does not match a capability of the UE;
the UE detects that resource allocation scheduled by the DCI does not match a capability of the UE, for example, resource allocation scheduled by the PDCCH is greater than 5 MHz, which exceeds a processing capability of the UE;
the UE fails to demodulate a MAC PDU, that is, a Msg4;
the UE fails to demodulate a MAC PDU, that is, a Msg4, because it exceeds a capability of the UE;
the UE detects a PDCCH scrambled by a T-C-RNTI of the UE, but the UE detects that a PDSCH scheduled by the DCI is greater than a preset threshold;
the UE detects a PDCCH scrambled by a T-C-RNTI of the UE, but the UE detects that resource allocation scheduled by the DCI is greater than a preset threshold;
the UE detects a PDCCH scrambled by a T-C-RNTI of the UE but detects that a PDSCH scheduled by the DCI does not match a capability of the UE;
the UE detects a PDCCH scrambled by a T-C-RNTI of the UE but detects that resource allocation scheduled by the DCI does not match a capability of the UE;
the UE detects a PDCCH scrambled by a T-C-RNTI of the UE but fails to demodulate a MAC PDU, that is, a Msg4; and
the UE detects a PDCCH scrambled by a T-C-RNTI of the UE but fails to demodulate a MAC PDU, that is, a Msg4, because it exceeds a capability of the UE.

The preset threshold includes at least one of the following:
a value agreed upon in a protocol, for example, 5 MHz;
a value configured by a network;
a receiving or processing capability of the UE; and
capabilities of some UEs of UE type, where the UE type is UE type to which the UE belongs.

That the scheduled PDSCH or resource does not match the capability of the UE includes at least one of the following:
the scheduled PDSCH or resource exceeds a receiving or processing capability of the UE; and
the scheduled PDSCH or resource exceeds capabilities of some UEs of the UE type, where the UE type is UE type to which the UE belongs.

For example, there may be two implementations for an eRedCap UE: One is 20 MHz+PR1, and the other is BW3/PR3+PR1. Both implementations can meet approximately 10 Mbps required by the eRedCap UE.

The scheduled PDSCH or resource herein may be greater than 5 MHz, that is, exceeds a capability corresponding to UE in the implementation BW3/PR3+PR1, and may not exceed a capability corresponding to UE in the implementation 20 MHz+PR1.

The receiving capability or the processing capability of the UE includes at least one of the following:
radio frequency bandwidth, baseband bandwidth, operating bandwidth, a quantity of antennas, a codeword, and a time domain processing interval.

The first operation includes at least one of the following:
considering that contention resolution fails;
discarding a T-C-RNTI;
stopping a contention resolution timer;
discarding an undemodulated MAC PDU; and
instructing the physical layer to retransmit a random access preamble.

The foregoing indication is used to indicate at least one of the following:
the UE fails to demodulate a PDSCH/Msg4;
a current PDSCH/Msg4 does not belong to the current UE;
the UE detects that the PDSCH scheduled by the DCI is greater than the preset threshold;
the UE detects that the resource allocation scheduled by the DCI is greater than the preset threshold;
the UE detects that the PDSCH scheduled by the DCI does not match the capability of the UE;
the UE detects that the resource allocation scheduled by the DCI does not match the capability of the UE, for example, resource allocation scheduled by the PDCCH is greater than 5 MHz, which exceeds the processing capability of the UE;
the UE fails to demodulate a MAC PDU, that is, a Msg4;
the UE fails to demodulate a MAC PDU, that is, a Msg4, because it exceeds the capability of the UE;
the UE detects a PDCCH scrambled by a T-C-RNTI of the UE, but the UE detects that a PDSCH scheduled by the DCI is greater than the preset threshold;
the UE detects a PDCCH scrambled by a T-C-RNTI of the UE, but the UE detects that resource allocation scheduled by the DCI is greater than the preset threshold;
the UE detects a PDCCH scrambled by a T-C-RNTI of the UE, but detects that a PDSCH scheduled by the DCI does not match the capability of the UE;
the UE detects a PDCCH scrambled by a T-C-RNTI of the UE, but detects that resource allocation scheduled by the DCI does not match the capability of the UE;
the UE detects a PDCCH scrambled by a T-C-RNTI of the UE but fails to demodulate a MAC PDU, that is, a Msg4; and
the UE detects a PDCCH scrambled by a T-C-RNTI of the UE, but the UE fails to demodulate a MAC PDU, that is, a Msg4, because it exceeds the capability of the UE.

This embodiment of this application may be implemented as follows:
the PHY layer sends an indication to a higher layer based on detecting that the PDSCH scheduled by the PDCCH exceeds the capability of the UE or exceeds a specific preset threshold; and
the MAC layer determines, based on an indication from a lower layer, that contention resolution fails, and stops a contention resolution timer in advance.

In this way, the contention resolution timer can be aborted in advance to initiate a next RACH attempt.

### Embodiment 2

This embodiment mainly describes a 2-step RACH, which is specifically as follows:

For the 2-step RACH, processing of a MsgB may be similar to processing of a Msg2 RAR or processing of a Msg4.

Processing of the MsgB is similar to processing of a Msg2. If bandwidth scheduling exceeds 5 MHz and a HARQ-ACK timing meets a relaxation requirement, UE demodulates the MsgB and transmits a HARQ. Otherwise, a physical layer needs to perform reporting to a higher layer.

Specifically,
the PHY layer of the UE provides an indication (or notification) to an upper layer (that is, a MAC layer) when a first condition is met; and
the MAC layer of the UE performs a first operation if the foregoing indication is received from a lower layer (that is, the PHY layer).

The first condition includes at one of the following:
the UE detects that a PDSCH (that is, a MsgB) scheduled by DCI is greater than a preset threshold;
the UE detects that resource allocation of a PDSCH (that is, a MsgB) scheduled by DCI is greater than a preset threshold;
a HARQ-ACK timing does not meet a requirement, that is, does not meet a corresponding relaxation requirement;
the UE detects that a PDSCH (that is, a MsgB) scheduled by DCI does not match a capability of the UE;
the UE detects that resource allocation of a PDSCH (that is, a MsgB) scheduled by DCI does not match a capability of the UE, for example, resource allocation scheduled by a PDCCH is greater than 5 MHz, which exceeds a processing capability of the UE;
the UE fails to demodulate a PDSCH (that is, a MsgB);
the UE fails to demodulate a PDSCH (that is, a MsgB) because it exceeds a capability of the UE;
the UE detects a PDCCH scrambled by a MsgB-RNTI of the UE, but the UE detects that a PDSCH (that is, a MsgB) scheduled by DCI is greater than a preset threshold;
the UE detects a PDCCH scrambled by a MsgB-RNTI of the UE, but the UE detects that resource allocation of a PDSCH (that is, a MsgB) scheduled by DCI is greater than a preset threshold;
the UE detects a PDCCH scrambled by a MsgB-RNTI of the UE but detects that a PDSCH (that is, a MsgB) scheduled by DCI does not match a capability of the UE;
the UE detects a PDCCH scrambled by a MsgB-RNTI of the UE but detects that resource allocation of a PDSCH (that is, a MsgB) scheduled by DCI does not match a capability of the UE;
the UE detects a PDCCH scrambled by a MsgB-RNTI of the UE but fails to demodulate a PDSCH (that is, a MsgB), that is, a MAC PDU; and
the UE detects a PDCCH scrambled by a MsgB-RNTI of the UE but fails to demodulate a MAC PDU, that is, a MsgB, because it exceeds a capability of the UE.

The first operation includes at least one of the following:
considering that a RAR fails to be received;
stopping a MsgB response window;
discarding an undemodulated MAC PDU;
instructing the physical layer to retransmit a PRACH; and
determining that a RACH fails to be completed.

Processing of the MsgB is similar to processing of the Msg4. If bandwidth scheduling exceeds 5 MHz, the UE does not perform processing, and the physical layer needs to perform reporting to a higher layer.

Specifically,
the PHY layer of the UE provides an indication (or notification) to an upper layer (that is, a MAC layer) when a first condition is met; and
the MAC layer of the UE performs a first operation if the indication is received from a lower layer (that is, the PHY layer).

The first condition includes at one of the following:
the UE detects that a PDSCH (that is, a MsgB) scheduled by DCI is greater than a preset threshold;
the UE detects that resource allocation of a PDSCH (that is, a MsgB) scheduled by DCI is greater than a preset threshold;
the UE detects that a PDSCH (that is, a MsgB) scheduled by DCI does not match a capability of the UE;
the UE detects that resource allocation of a PDSCH (that is, a MsgB) scheduled by DCI does not match a capability of the UE, for example, resource allocation scheduled by a PDCCH is greater than 5 MHz, which exceeds a processing capability of the UE;
the UE fails to demodulate a PDSCH (that is, a MsgB);
the UE fails to demodulate a PDSCH (that is, a MsgB) because it exceeds a capability of the UE;
the UE detects a PDCCH scrambled by a MsgB-RNTI of the UE, but the UE detects that a PDSCH (that is, a MsgB) scheduled by DCI is greater than a preset threshold;
the UE detects a PDCCH scrambled by a MsgB-RNTI of the UE, but the UE detects that resource allocation of a PDSCH (that is, a MsgB) scheduled by DCI is greater than a preset threshold;
the UE detects a PDCCH scrambled by a MsgB-RNTI of the UE but detects that a PDSCH (that is, a MsgB) scheduled by DCI does not match a capability of the UE;
the UE detects a PDCCH scrambled by a MsgB-RNTI of the UE but detects that resource allocation of a PDSCH (that is, a MsgB) scheduled by the DCI does not match a capability of the UE;
the UE detects a PDCCH scrambled by a MsgB-RNTI of the UE but fails to demodulate a PDSCH (that is, a MsgB), that is, a MAC PDU; and
the UE detects a PDCCH scrambled by a MsgB-RNTI of the UE but fails to demodulate a PDSCH (that is, a MsgB), that is, a MAC PDU, because it exceeds a capability of the UE.

### Embodiment 3

In some related technologies, if UE demodulates a PDCCH scrambled by a T-C-RNTI of the UE,
if a Msg4, that is, a MAC PDU, fails to be demodulated, the UE continues to wait until a contention resolution timer expires to initiate a next RACH attempt; and
if a Msg4, that is, a MAC PDU, is demodulated, that is, a contention resolution ID included in the MAC PDU matches a CCCH SDU transmitted by the UE in a Msg3, it is considered that contention resolution succeeds, or otherwise, it is considered that contention resolution fails.

In this embodiment, if a PHY layer of the UE meets the first condition, even if the UE can demodulate a PDCCH, the PHY layer does not submit an indication to an upper layer, and the indication is used to indicate that the UE receives PDCCH transmission of a special cell (Spcell).

The detection processing method provided in the embodiments of this application may be performed by a detection processing apparatus. In the embodiments of this application, that the detection processing apparatus performs the detection processing method is used as an example to describe the detection processing apparatus provided in the embodiments of this application.

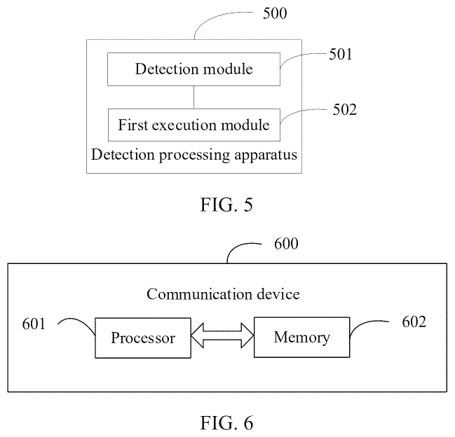

Referring to FIG. 5, FIG. 5 is a structural diagram of a detection processing apparatus according to an embodiment of this application. As shown in FIG. 5, a detection processing apparatus 500 includes:
a detection module 501, configured to detect a downlink channel; and
a first execution module 502, configured to perform a first operation when a first condition is met, where the first operation includes a related operation of a contention resolution failure; where
the first condition includes at least one of the following:
the downlink channel includes a physical downlink shared channel (PDSCH), and the PDSCH does not match a capability of the UE;
the downlink channel includes a physical downlink shared channel (PDSCH), and a resource of the PDSCH exceeds a first preset threshold;
the downlink channel includes a physical downlink control channel (PDCCH), and a resource of a PDSCH scheduled by the PDCCH does not match a capability of the UE;
the downlink channel includes a PDCCH, and a resource of a PDSCH scheduled by the PDCCH exceeds a first preset threshold;
the downlink channel includes a PDCCH, and the PDCCH does not match a capability of the UE;
the downlink channel includes a PDCCH, and a resource scheduled by the PDCCH exceeds a second preset threshold;
the downlink channel includes a PDSCH, and the PDSCH fails to be demodulated; and
the downlink channel includes a PDCCH, and a PDSCH scheduled by the PDCCH fails to be demodulated.

Optionally, a reason why the PDSCH fails to be demodulated or the PDSCH scheduled by the PDCCH fails to be demodulated includes at least one of the following:
the resource of the PDSCH does not match the capability of the UE; and
the resource of the PDSCH exceeds the first preset threshold.

Optionally, a value of the first preset threshold includes one of the following:
a value agreed upon in a protocol;
a value configured by a network;
a value corresponding to a receiving capability of the UE or a value corresponding to a processing capability of the UE; and
a value corresponding to receiving capabilities of some UEs of UE type to which the UE belongs, or a value corresponding to processing capabilities of some UEs of UE type to which the UE belongs.

Optionally, the first execution module 502 is configured to: send, by the physical layer of the UE, first indication information to an upper layer of the UE when the physical layer meets the first condition; and perform, by the upper layer of the UE, the first operation when receiving the first indication information.

Optionally, the first indication information is used to indicate any one of the following:
being unable to demodulate the PDSCH;
the PDSCH does not belong to the UE;
the PDSCH does not match the capability of the UE;
the resource of the PDSCH exceeds the first preset threshold;
the resource of the PDSCH scheduled by the PDCCH does not match the capability of the UE;
the resource of the PDSCH scheduled by the PDCCH exceeds the first preset threshold;
the PDCCH does not match the capability of the UE;
the resource scheduled by the PDCCH exceeds the second preset threshold;
the UE fails to demodulate the PDSCH;
the UE fails to demodulate the PDSCH scheduled by the PDCCH; and
the first condition is met.

Optionally, that the PDSCH does not match the capability of the UE includes:
the UE detects a PDCCH scrambled by a radio network temporary identifier (RNTI) of the UE, but the PDSCH scheduled by the PDCCH does not match the capability of the UE;
or
that the resource of the PDSCH scheduled by the PDCCH does not match the capability of the UE includes:
the UE detects a PDCCH scrambled by an RNTI of the UE, but the resource of the PDSCH scheduled by the PDCCH does not match the capability of the UE;
or
that the resource of the PDSCH scheduled by the PDCCH exceeds the first preset threshold includes:
the UE detects a PDCCH scrambled by an RNTI of the UE, but the resource of the PDSCH scheduled by the PDCCH exceeds the first preset threshold;
or
that the PDCCH does not match the capability of the UE includes:
the UE detects a PDCCH scrambled by an RNTI of the UE, but the PDCCH does not match the capability of the UE;
or
that the resource scheduled by the PDCCH exceeds the second preset threshold includes:
the UE detects a PDCCH scrambled by an RNTI of the UE, but the resource scheduled by the PDCCH exceeds the second preset threshold;
or
that the PDSCH fails to be demodulated includes:
the UE detects a PDCCH scrambled by an RNTI of the UE, but fails to demodulate the PDSCH;
or
that the PDSCH scheduled by the PDCCH fails to be demodulated includes:
the UE detects a PDCCH scrambled by an RNTI of the UE, but fails to demodulate the PDSCH scheduled by the PDCCH; where
the RNTI includes:
a temporary cell radio network temporary identifier (T-C-RNTI) or a message B-RNTI.

Optionally, the resource includes at least one of the following:
bandwidth, a frequency domain resource, a time domain resource, a space domain resource, and a code domain resource.

Optionally, that the PDSCH does not match the capability of the UE includes at least one of the following:
bandwidth of the PDSCH does not match the capability of the UE; and
a resource of the PDSCH does not match the capability of the UE.

Optionally, the capability of the UE includes at least one of the following:
the receiving capability of the UE;
the processing capability of the UE;
the receiving capabilities of some UEs of the UE type to which the UE belongs; and
the processing capabilities of some UEs of the UE type to which the UE belongs.

Optionally, the capability of the UE includes at least one of the following:
radio frequency bandwidth, baseband bandwidth, operating bandwidth, a quantity of antennas, a codeword, and a time domain processing interval.

Optionally, the PDSCH includes at least one of the following:
a message 4 in four-step random access; and
a message B in two-step random access.

Optionally, the related operation of the contention resolution failure includes at least one of the following:
determining the contention resolution failure, discarding a T-C-RNTI, stopping a contention resolution timer, discarding an undemodulated PDSCH, and instructing the physical layer to retransmit a random access preamble.

Optionally, when the PDSCH includes a message B in two-step random access, the related operation of the contention resolution failure includes at least one of the following:
determining that a random access response RAR fails to be received;
stopping a timing corresponding to a response window of the message B;
discarding the undemodulated PDSCH;
instructing the physical layer to retransmit the random access preamble; and
determining that random access fails.

Optionally, when the PDSCH includes a message B in two-step random access, the first condition further includes:
a hybrid automatic repeat request acknowledgement (HARQ-ACK) timing of the PDSCH does not meet a relaxation requirement.

Optionally, when the PDSCH includes a message B in two-step random access, the apparatus further includes:
a second execution module, configured to perform a second operation when a HARQ-ACK timing of the PDSCH meets a relaxation requirement, where the second operation includes at least one of the following:
demodulating the PDSCH; and
transmitting a HARQ of the PDSCH.

Optionally, when the PDSCH includes a message B in two-step random access, that the PDSCH does not match the capability of the UE includes:
bandwidth of the PDSCH does not match the capability of the UE, and a HARQ-ACK timing of the PDSCH does not meet a relaxation requirement.

Optionally, when the first condition is met, and the PDCCH is demodulated by the UE, the physical layer of the UE does not send second indication information to the upper layer, where the second indication information is used to indicate the receipt of a PDCCH of a special cell (Spcell).

The foregoing detection processing apparatus can improve communication performance of the UE.

The detection processing apparatus in this embodiment of this application may be an electronic device, for example, an electronic device with an operating system, or may be a component in the electronic device, for example, an integrated circuit or a chip. The electronic device may be UE, or another device other than the UE. For example, the UE may include but is not limited to the foregoing listed types of the UE 11, and the another device may be a server, a network attached storage (NAS), or the like. This is not specifically limited in this embodiment of this application.

The detection processing apparatus provided in this embodiment of this application can implement the processes implemented in the method embodiment in FIG. 4, and a same technical effect is achieved. To avoid repetition, details are not described herein again.

As shown in FIG. 6, an embodiment of this application further provides a communication device 600, including a processor 601 and a memory 602, and the memory 602 stores a program or instructions capable of being run on the processor 601. For example, when the communication device 600 is UE, the steps of the foregoing embodiment of the detection processing method are implemented when the program or the instructions are executed by the processor 601, and a same technical effect can be achieved. When the communications device 600 is a network side device, the steps of the foregoing method of the detection processing method are implemented when the program or the instructions are executed by the processor 601, and a same technical effect can be achieved. To avoid repetition, details are not described herein again.

An embodiment of this application further provides UE, including a processor and a communication interface. The communication interface is used by a detection module to detect a downlink channel. The processor is configured to perform a first operation when a first condition is met, where the first operation includes a related operation of a contention resolution failure, and the first condition includes at least one of the following: the downlink channel includes a physical downlink shared channel (PDSCH), and the PDSCH does not match a capability of the UE; the downlink channel includes a physical downlink shared channel (PDSCH), and a resource of the PDSCH exceeds a first preset threshold; the downlink channel includes a physical downlink control channel (PDCCH), and a resource of a PDSCH scheduled by the PDCCH does not match a capability of the UE; the downlink channel includes a PDCCH, and a resource of a PDSCH scheduled by the PDCCH exceeds a first preset threshold; the downlink channel includes a PDCCH, and the PDCCH does not match a capability of the UE; the downlink channel includes a PDCCH, and a resource scheduled by the PDCCH exceeds a second preset threshold; the downlink channel includes a PDSCH, and the PDSCH fails to be demodulated; and the downlink channel includes a PDCCH, and a PDSCH scheduled by the PDCCH fails to be demodulated.

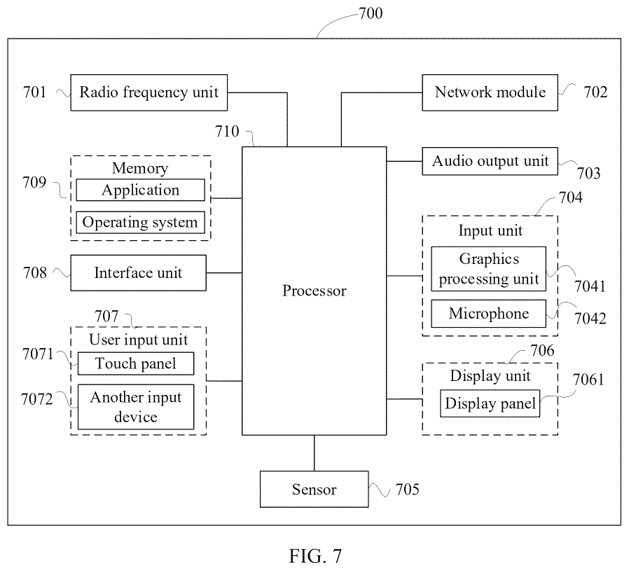

An embodiment of this application further provides UE, including a processor and a communication interface. The communication interface is coupled to the processor, and the processor is configured to run a program or instructions, to implement the steps in the method embodiment shown in FIG. 4. This UE embodiment corresponds to the method embodiment on the UE side, each implementation process and implementation manner of the method embodiment can be applied to the UE embodiment, and a same technical effect can be achieved. Specifically, FIG. 7 is a schematic diagram of a hardware structure of UE according to an embodiment of this application.

The UE 700 includes but is not limited to at least a part of components such as a radio frequency unit 701, a network module 702, an audio output unit 703, an input unit 704, a sensor 705, a display unit 706, a user input unit 707, an interface unit 708, a memory 709, and a processor 710.

It may be understood by a person skilled in the art that the UE 700 may further include a power supply (such as a battery) that supplies power to each component. The power supply may be logically connected to the processor 710 by using a power management system, to implement functions such as charging, discharging, and power consumption management by using the power management system. The UE structure shown in FIG. 7 constitutes no limitation on the UE, and the UE may include more or fewer components than those shown in the figure, or combine some components, or have different component arrangements. Details are not described herein.

It should be understood that in this embodiment of this application, the input unit 704 may include a graphics processing unit (GPU) 7041 and a microphone 7042. The graphics processing unit 7041 processes image data of a static picture or a video obtained by an image capture apparatus (for example, a camera) in a video capture mode or an image capture mode. The display unit 706 may include a display panel 7061, and the display panel 7061 may be configured in a form of a liquid crystal display, an organic light-emitting diode, or the like. The user input unit 707 includes at least one of a touch panel 7071 and another input device 7072. The touch panel 7071 is also referred to as a touchscreen. The touch panel 7071 may include two parts: a touch detection apparatus and a touch controller. The another input device 7072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 701 may transmit the downlink data to the processor 710 for processing. In addition, the radio frequency unit 701 may send uplink data to the network side device. Generally, the radio frequency unit 701 includes but is not limited to an antenna, an amplifier, a transceiver, a coupler, a low noise amplifier, a duplexer, and the like.

The memory 709 may be configured to store a software program or an instruction and various data. The memory 709 may mainly include a first storage area for storing a program or an instruction and a second storage area for storing data. The first storage area may store an operating system, and an application or an instruction required by at least one function (for example, a sound playing function or an image playing function). In addition, the memory 709 may include a volatile memory or a non-volatile memory. The nonvolatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (Random Access Memory, RAM), a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synch link dynamic random access memory (SLDRAM), and a direct rambus random access memory (DRRAM). The memory 709 in this embodiment of this application includes but is not limited to these memories and any memory of another proper type.

The processor 710 may include one or more processing units. Optionally, an application processor and a modem processor are integrated into the processor 710. The application processor mainly processes an operating system, a user interface, an application, or the like. The modem processor mainly processes a wireless communication signal, for example, a baseband processor. It may be understood that, alternatively, the modem processor may not be integrated into the processor 710.

The radio frequency unit 701 is configured to detect a downlink channel.

The processor 710 is configured to perform a first operation when a first condition is met, where the first operation includes a related operation of a contention resolution failure.

The first condition includes at least one of the following:
the downlink channel includes a physical downlink shared channel (PDSCH), and the PDSCH does not match a capability of the UE;
the downlink channel includes a physical downlink shared channel (PDSCH), and a resource of the PDSCH exceeds a first preset threshold;
the downlink channel includes a physical downlink control channel (PDCCH), and a resource of a PDSCH scheduled by the PDCCH does not match a capability of the UE;
the downlink channel includes a PDCCH, and a resource of a PDSCH scheduled by the PDCCH exceeds a first preset threshold;
the downlink channel includes a PDCCH, and the PDCCH does not match a capability of the UE;
the downlink channel includes a PDCCH, and a resource scheduled by the PDCCH exceeds a second preset threshold;
the downlink channel includes a PDSCH, and the PDSCH fails to be demodulated; and
the downlink channel includes a PDCCH, and a PDSCH scheduled by the PDCCH fails to be demodulated.

Optionally, a reason why the PDSCH fails to be demodulated or the PDSCH scheduled by the PDCCH fails to be demodulated includes at least one of the following:
the resource of the PDSCH does not match the capability of the UE; and
the resource of the PDSCH exceeds the first preset threshold.

Optionally, a value of the first preset threshold includes one of the following:
a value agreed upon in a protocol;
a value configured by a network;
a value corresponding to a receiving capability of the UE or a value corresponding to a processing capability of the UE; and
a value corresponding to receiving capabilities of some UEs of UE type to which the UE belongs, or a value corresponding to processing capabilities of some UEs of UE type to which the UE belongs.

Optionally, the performing a first operation when a first condition is met includes:
sending, by a physical layer of the UE, first indication information to an upper layer of the UE when the physical layer meets the first condition; and
performing, by the upper layer of the UE, the first operation when receiving the first indication information.

Optionally, the first indication information is used to indicate any one of the following:
being unable to demodulate the PDSCH;
the PDSCH does not belong to the UE;
the PDSCH does not match the capability of the UE;
the resource of the PDSCH exceeds the first preset threshold;
the resource of the PDSCH scheduled by the PDCCH does not match the capability of the UE;
the resource of the PDSCH scheduled by the PDCCH exceeds the first preset threshold;
the PDCCH does not match the capability of the UE;
the resource scheduled by the PDCCH exceeds the second preset threshold;
the UE fails to demodulate the PDSCH;
the UE fails to demodulate the PDSCH scheduled by the PDCCH; and
the first condition is met.

Optionally, that the PDSCH does not match the capability of the UE includes:
the UE detects a PDCCH scrambled by a radio network temporary identifier (RNTI) of the UE, but the PDSCH scheduled by the PDCCH does not match the capability of the UE;
or
that the resource of the PDSCH scheduled by the PDCCH does not match the capability of the UE includes:
the UE detects a PDCCH scrambled by an RNTI of the UE, but the resource of the PDSCH scheduled by the PDCCH does not match the capability of the UE;
or
that the resource of the PDSCH scheduled by the PDCCH exceeds the first preset threshold includes:
the UE detects a PDCCH scrambled by an RNTI of the UE, but the resource of the PDSCH scheduled by the PDCCH exceeds the first preset threshold;
or
that the PDCCH does not match the capability of the UE includes:
the UE detects a PDCCH scrambled by an RNTI of the UE, but the PDCCH does not match the capability of the UE;
or
that the resource scheduled by the PDCCH exceeds the second preset threshold includes:
the UE detects a PDCCH scrambled by an RNTI of the UE, but the resource scheduled by the PDCCH exceeds the second preset threshold;
or
that the PDSCH fails to be demodulated includes:
the UE detects a PDCCH scrambled by an RNTI of the UE, but fails to demodulate the PDSCH;
or
that the PDSCH scheduled by the PDCCH fails to be demodulated includes:
the UE detects a PDCCH scrambled by an RNTI of the UE, but fails to demodulate the PDSCH scheduled by the PDCCH; where
the RNTI includes:
a temporary cell radio network temporary identifier (T-C-RNTI) or a message B-RNTI.

Optionally, the resource includes at least one of the following:
bandwidth, a frequency domain resource, a time domain resource, a space domain resource, and a code domain resource.

Optionally, that the PDSCH does not match the capability of the UE includes at least one of the following:
bandwidth of the PDSCH does not match the capability of the UE; and
a resource of the PDSCH does not match the capability of the UE.

Optionally, the capability of the UE includes at least one of the following:
the receiving capability of the UE;
the processing capability of the UE;
the receiving capabilities of some UEs of the UE type to which the UE belongs; and
the processing capabilities of some UEs of the UE type to which the UE belongs.

Optionally, the capability of the UE includes at least one of the following:
radio frequency bandwidth, baseband bandwidth, operating bandwidth, a quantity of antennas, a codeword, and a time domain processing interval.

Optionally, the PDSCH includes at least one of the following:
a message 4 in four-step random access; and
a message B in two-step random access.

Optionally, the related operation of the contention resolution failure includes at least one of the following:
determining the contention resolution failure, discarding a T-C-RNTI, stopping a contention resolution timer, discarding an undemodulated PDSCH, and instructing the physical layer to retransmit a random access preamble.

Optionally, when the PDSCH includes a message B in two-step random access, the related operation of the contention resolution failure includes at least one of the following:
determining that a random access response (RAR) fails to be received;
stopping a timing corresponding to a response window of the message B;
discarding the undemodulated PDSCH;
instructing the physical layer to retransmit the random access preamble; and
determining that random access fails.

Optionally, when the PDSCH includes a message B in two-step random access, the first condition further includes:
a hybrid automatic repeat request acknowledgement (HARQ-ACK) timing of the PDSCH does not meet a relaxation requirement.

Optionally, when the PDSCH includes the message B in two-step random access, the processor 710 is further configured to:
perform a second operation when a HARQ-ACK timing of the PDSCH meets a relaxation requirement, where the second operation includes at least one of the following:
demodulating the PDSCH; and
transmitting a HARQ of the PDSCH.

Optionally, when the PDSCH includes a message B in two-step random access, that the PDSCH does not match the capability of the UE includes:
bandwidth of the PDSCH does not match the capability of the UE, and a HARQ-ACK timing of the PDSCH does not meet a relaxation requirement.

Optionally, when the first condition is met, and the UE demodulates the PDCCH, the physical layer of the UE does not send second indication information to the upper layer, where the second indication information is used to indicate the receipt of a PDCCH of a special cell (Spcell).

The foregoing UE can improve communication performance of the UE.

It may be understood that, for an implementation process of the implementations mentioned in this embodiment, reference may be made to related descriptions of the method embodiments, and a same or corresponding technical effect is achieved. To avoid repetition, details are not described herein again.

An embodiment of this application further provides a readable storage medium. The readable storage medium stores a program or instructions. When the program or the instructions are executed by a processor, the processes of the foregoing embodiment of the detection processing method are implemented, and a same technical effect can be achieved. To avoid repetition, details are not described herein.

The processor is a processor in the UE in the foregoing embodiments. The readable storage medium includes a computer-readable storage medium, such as a computer read-only memory (ROM), a random access memory (RAM), a magnetic disk, or an optical disc. In some examples, the readable storage medium may be a non-transient readable storage medium.

An embodiment of this application further provides a chip. The chip includes a processor and a communication interface, the communication interface is coupled to the processor, and the processor is configured to run a program or instructions to implement the processes of the foregoing embodiment of the detection processing method, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product, the computer program/program product is stored in a non-volatile storage medium, and the computer program/program product is executed by at least one processor to implement the processes of the foregoing embodiment of the detection processing method, and a same technical effect can be achieved. To avoid repetition, details are not described herein again.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the descriptions of the foregoing implementations, a person skilled in the art may clearly understand that the method in the foregoing embodiment may be implemented by a computer software product in addition to a necessary universal hardware platform or certainly by hardware. The computer software product is stored in a storage medium (such as a ROM, a RAM, a magnetic disk, or an optical disc), and includes several instructions for instructing UE or a network side device to perform the methods described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms of implementations without departing from the purpose of this application and the protection scope of the claims, all of which fall within the protection of this application.

What is claimed is

1. A detection processing method, wherein the method comprises:
detecting, by user equipment (UE), a downlink channel; and
performing, by the UE, a first operation when a first condition is met, wherein the first operation comprises a related operation of a contention resolution failure; wherein
the first condition comprises at least one of the following:
the downlink channel comprises a physical downlink shared channel (PDSCH), and the PDSCH does not match a capability of the UE;
the downlink channel comprises a PDSCH, and a resource of the PDSCH exceeds a first preset threshold; the downlink channel comprises a physical downlink control channel (PDCCH), and a resource of a PDSCH scheduled by the PDCCH does not match a capability of the UE;
the downlink channel comprises a PDSCH, and the PDSCH fails to be demodulated; and
the downlink channel comprises a PDCCH, and a PDSCH scheduled by the PDCCH fails to be demodulated.

2. The method according to claim 1, wherein a reason why the PDSCH fails to be demodulated or the PDSCH scheduled by the PDCCH fails to be demodulated comprises:
the resource of the PDSCH does not match the capability of the UE.

3. The method according to claim 1, wherein a value of the first preset threshold comprises:
a value corresponding to a receiving capability of the UE or a value corresponding to a processing capability of the UE.

4. The method according to claim 1, wherein the performing, by the UE, a first operation when a first condition is met comprises:
sending, by a physical layer of the UE, first indication information to an upper layer of the UE when the physical layer meets the first condition.

5. The method according to claim 4, wherein the first indication information is used to indicate:
the PDSCH does not match the capability of the UE.

6. The method according to claim 1, wherein that the PDSCH does not match the capability of the UE comprises:
the UE detects a PDCCH scrambled by a radio network temporary identifier (RNTI) of the UE, but the PDSCH scheduled by the PDCCH does not match the capability of the UE;
or
that the resource of the PDSCH scheduled by the PDCCH does not match the capability of the UE comprises:
the UE detects a PDCCH scrambled by an RNTI of the UE, but the resource of the PDSCH scheduled by the PDCCH does not match the capability of the UE;
or
that the resource of the PDSCH scheduled by the PDCCH exceeds the first preset threshold comprises:
the UE detects a PDCCH scrambled by an RNTI of the UE, but the resource of the PDSCH scheduled by the PDCCH exceeds the first preset threshold;
or
that the PDCCH does not match the capability of the UE comprises:
the UE detects a PDCCH scrambled by an RNTI of the UE, but the PDCCH does not match the capability of the UE;
or
that the resource scheduled by the PDCCH exceeds a second preset threshold comprises:
the UE detects a PDCCH scrambled by an RNTI of the UE, but the resource scheduled by the PDCCH exceeds the second preset threshold;
or
that the PDSCH fails to be demodulated comprises:
the UE detects a PDCCH scrambled by an RNTI of the UE, but fails to demodulate the PDSCH;
or
that the PDSCH scheduled by the PDCCH fails to be demodulated comprises:
the UE detects a PDCCH scrambled by an RNTI of the UE, but fails to demodulate the PDSCH scheduled by the PDCCH; wherein
the RNTI comprises:
a temporary cell radio network temporary identifier (T-C-RNTI) or a message B-RNTI.

7. The method according to claim 1, wherein the resource comprises:
bandwidth.

8. The method according to claim 1, wherein that the PDSCH does not match the capability of the UE comprises at least one of the following:
bandwidth of the PDSCH does not match the capability of the UE; and
a resource of the PDSCH does not match the capability of the UE.

9. The method according to claim 1, wherein the capability of the UE comprises at least one of the following:
the receiving capability of the UE;
the processing capability of the UE;
the receiving capabilities of some UEs of the UE type to which the UE belongs; and
the processing capabilities of some UEs of the UE type to which the UE belongs.

10. The method according to claim 1, wherein the capability of the UE comprises at least one of the following:
radio frequency bandwidth, baseband bandwidth, operating bandwidth, a quantity of antennas, a codeword, and a time domain processing interval.

11. The method according to claim 1, wherein the PDSCH comprises at least one of the following:
a message 4 in four-step random access; and
a message B in two-step random access.

12. The method according to claim 11, wherein when the PDSCH comprises a message B in two-step random access, the related operation of the contention resolution failure comprises at least one of the following:
determining that a random access response (RAR) fails to be received;
stopping a timing corresponding to a response window of the message B;
discarding the undemodulated PDSCH;
instructing the physical layer to retransmit the random access preamble; and
determining that random access fails.

13. The method according to claim 11, wherein when the PDSCH comprises a message B in two-step random access, the first condition further comprises:
a hybrid automatic repeat request acknowledgement (HARQ-ACK) timing of the PDSCH does not meet a relaxation requirement.

14. The method according to claim 11, wherein when the PDSCH comprises a message B in two-step random access, the method further comprises:
performing, by the UE, a second operation when a HARQ-ACK timing of the PDSCH meets a relaxation requirement, wherein the second operation comprises at least one of the following:
demodulating the PDSCH; and
transmitting a HARQ of the PDSCH.

15. The method according to claim 11, wherein when the PDSCH comprises a message B in two-step random access, that the PDSCH does not match the capability of the UE comprises:
bandwidth of the PDSCH does not match the capability of the UE, and a HARQ-ACK timing of the PDSCH does not meet a relaxation requirement.

16. The method according to claim 1, wherein the related operation of the contention resolution failure comprises at least one of the following:
determining the contention resolution failure, discarding a T-C-RNTI, and stopping a contention resolution timer.

17. The method according to claim 1, wherein when the first condition is met, and the PDCCH is demodulated by the UE, the physical layer of the UE does not send second indication information to the upper layer, wherein the second indication information is used to indicate the receipt of a PDCCH of a special cell (Spcell).

18. The method according to claim 1, wherein that the resource of the PDSCH does not match the capability of the UE comprises:
a bandwidth of the PDSCH exceeds the capability of the UE.

19. UE, comprising a processor and a memory, wherein the memory stores a program or instructions capable of being run on the processor, and when the program or the instructions are executed by the processor, the following operations are implemented:
detecting, by user equipment (UE), a downlink channel; and
performing, by the UE, a first operation when a first condition is met, wherein the first operation comprises a related operation of a contention resolution failure; wherein
the first condition comprises at least one of the following:
the downlink channel comprises a physical downlink shared channel (PDSCH), and the PDSCH does not match a capability of the UE; and
the downlink channel comprises a physical downlink control channel (PDCCH), and a resource of a PDSCH scheduled by the PDCCH does not match a capability of the UE.

20. A non-transitory readable storage medium, wherein the readable storage medium stores a program or instructions, and when the program or the instructions are executed by a processor, the following operations are implemented;
detecting, by user equipment (UE), a downlink channel; and
performing, by the UE, a first operation when a first condition is met, wherein the first operation comprises a related operation of a contention resolution failure; wherein
the first condition comprises at least one of the following:
the downlink channel comprises a physical downlink shared channel (PDSCH), and the PDSCH does not match a capability of the UE; and
the downlink channel comprises a physical downlink control channel (PDCCH), and a resource of a PDSCH scheduled by the PDCCH does not match a capability of the UE.
